(19) United States
(12) Patent Application Publication
(10) Pub. No.: US 2007/0254133 A1
(43) Pub. Date: Nov. 1, 2007

(54) Apparatus and method of manufacturing a stone appearing post cover

(75) Inventors: Gioacchino M. Montanile, Haverhill, MA (US); Brian H. Boarder, Pelham, NH (US)

Correspondence Address: PEARSON & PEARSON, LLP, 10 GEORGE STREET, LOWELL, MA, 01852, US

(73) Assignee: Telcom USA, Inc.

(21) Appl. No.: 11/413,396

(22) Filed: Apr. 28, 2006

(51) Int. Cl. B32B 3/06

(52) U.S. Cl. 428/99; 428/15

(57) ABSTRACT

A thermoplastic post cover having a textured surface appearance of stone, and in particular granite, which is esthetically pleasing, light-weight and maintenance-free. The stone or granite appearing post cover is manufactured from a mold having an inner surface that produces a replica of a stone or granite post. The stone or granite appearing textured surface is produced from a model that is formed from the surface of a natural stone, such as granite, and incorporated in the mold.

### CROSS REFERENCE TO RELATED APPLICATIONS

This Nonprovisional Patent Application is being filed concurrently with Design Patent Application Entitled “POST COVER”, Attorney Docket No. 34028.

### BACKGROUND OF THE INVENTION

1. Field of the Invention

This invention relates generally to a thermoplastic post cover and, in particular, to a thermoplastic post cover having the appearance of stone, particularly granite, and the method of manufacturing the stone appearing post cover.

2. Description of Related Art

A thermoplastic post cover may be used to cover and protect a metal or wood post or pole and convert the visual appearance to substantially resemble a naturally occurring material including, but not limited to, stone or granite.

The appearance of poles has been enhanced by the addition of decorative covers primarily made of cast metal, which traditionally have been made by pouring molten metal into a sand mold. Due to the brittle material of the cast metal, and its relative high cost, alternative materials such as fiberglass and urethane have been used to duplicate the original castings in more recent years.

The appearance of wooden posts is either left natural or with the natural appearance of pressure treated wood. Wooden posts may be enhanced by the use of paint which results in constant re-painting as the coating fades. Recent developments have included extended tubes, molded panels as well as integration of a pole cover into functional items such as a mailbox. These improvements do address the issues of maintenance but limit the esthetic appeal to simple linear lines or geometric shapes.

Esthetically pleasing, maintenance free poles and posts are available in natural materials such as stone or granite, and these are expensive to buy, extremely heavy to handle and generally not installable without special equipment. These facts make the natural pole or post economically unfeasible for the average user or homeowner.

Prior art patents include U.S. Pat. No. 5,342,565, issued Aug. 30, 1994 to Jacob Goren, which discloses a method of manufacturing products having a granite appearance by coating a mold with a gel coat and then a spray composition including a gel coat material and crushed natural granite, crushed synthetic granite and mixtures thereof with backing materials filling the remainder of the mold. However, this method does not produce a consistent granite appearing surface that is rugged to withstand various outside weather elements. Also, additional protective packaging is required to prevent the crushed granite from separating from the backing material when storing or shipping the product.

U.S. Patent Publication No. US2001/0022056 A1, issued Sep. 20, 2001 to Thomas Gifford, discloses a two-piece decorative post cover which may be made of polyethylene, having L-shaped cover members connected to one another and surrounding a wooden post. The decorative members are made from an extrusion process from a plastic material such as polyvinyl or polyethylene. However, this post cover, which is made of plastic, does not provide a stone or granite appearance.

U.S. Pat. No. 6,722,561 B1, issued Apr. 20, 2004 to Eva M. Thomas, et al., discloses a mailbox assembly which includes a post cover assembly which is provided to fit over a wooden post, and is telescoping so that it slides into or out of itself providing height adjustment for proper installation. However, this post cover, which is made of plastic, does not provide a stone or granite appearance.

U.S. Pat. No. 6,878,325 B2, issued Apr. 12, 2005 to Stephen Drake, discloses a decorative hollow body post cover for a lamp post and describes a method of manufacturing the decorative post cover including making a female mold to have an impression of the outside of the desired cover, introducing a liquid thermosetting resin within the mold, rotating the mold about first and second axis, curing the liquid thermosetting resin as the mold is rotated to form a body with substantially uniform wall thickness, removing the cured liquid thermosetting resin from the mold, and cutting holes in the top and bottom of the cured thermosetting resin to receive the lamp post. However, this patent does not disclose how to make a post having a detailed stone or granite appearance.

It would be commercially important to have a post cover for a wooden or metal post or pole that is lightweight, easily handled and installable by a person of limited skills and tools, that has a desirable physical appearance of naturally occurring material, such as a granite surface that is maintenance free requiring no additional protection from the elements and no special packaging to prevent cracking or chipping.

### SUMMARY OF THE INVENTION

Accordingly, it is therefore an object of this invention to provide a stone or granite appearing post cover having the texture of a natural stone, such as, granite.

It is another object of this invention to provide a method of manufacturing a post cover, appearing as a decorative stone post, such as a granite post, by transferring the texture from a natural stone substance such as granite by the use of silicone on a wooden model, fabricating a cast aluminum rotational molding mold, introducing colored polyethylene resins of varying particle sizes, and commercially available pigments in varying amounts, and in some instances, mica, and other additives, such as commercially available flow agents.

It is another object of this invention to provide top and bottom openings for the post cover to accommodate circular poles and posts of various geometric shapes.

These and other objects are further accomplished by a post cover comprising walls having a textured surface with a stone appearance, the walls being made of a molded resin. The walls having a textured surface comprise a natural stone, such as, granite appearance. The post cover comprises a geometric form of lightweight, rectangular sides, a top having at least one of a closed or circular opening, and a bottom having a step-down extension. The post cover comprises a bottom having a circular opening, allowing the post cover to slip over a circular pole or post during installation. The cover comprises a thermoplastic resin, including, polyethylene. The lower portion of the post cover comprises the step-down extension wherein the lower portion may be cut-off to provide a predetermined length of the post cover, and the cut-off lower portion comprising the step-down extension, when turned around, plugs into an open end of the post cover to provide support for the open end of the post cover during storage and shipping. The bottom portion of the post cover comprises the step-down extension having an opening in the bottom portion for receiving a circular pole. The bottom portion of the post cover comprising the step-down extension is cut-off to provide a predetermined length of the post cover, and the bottom portion, when turned around, plugs into an open end of the post cover to provide support when receiving a circular pole passing though the post cover.

These objects are further accomplished by a method for manufacturing a post cover having a textured surface with a stone appearance, such as granite, comprising the steps of providing an object of natural material, applying a silicone material to the object at a predetermined thickness sufficient to maintain integrity of a cured first silicone sheet, removing the first silicone sheet from the natural material object to create a cured first silicone sheet having a reverse image of the natural material, creating a second silicone sheet having an exact image of the natural material, using the first silicone sheet as a mold, making a wooden model to resemble the shape of the post cover, fastening the second silicone sheet, having an exact image of the natural material, to the wooden model, creating foundry tooling from the wooden model, the foundry tooling being used to create the sand mold, the sand mold is used to receive the pouring of a melted aluminum to create a cast aluminum mold, adding a resin to the cast aluminum mold, curing the resin as the mold is rotated to form the post cover, and removing the cured resin post cover from the mold, the cured resin post cover having a the textured surface with a stone appearance of the object. The step of adding a resin to the mold comprises the step of adding a thermoplastic resin including polyethylene. In some instances, the method comprises the step of adding mica or other additives to the mold to enhance the appearance of the cured resin. The method comprises the step of providing a step-down extension on a lower portion of the post cover. The method comprises the steps of cutting-off a lower portion of the post cover having the step-down extension for providing a predetermined length of the post cover, turning around the cut-off lower portion of the post cover, and inserting the step-down extension of the lower portion into the open end of the post cover to provide support for the open end of the post cover. The method comprises the step of providing a circular opening in the top end and the bottom end of the post cover extension for receiving a circular pole passing through the post cover.

Additional objects, features and advantages of the invention will become apparent to those skilled in the art upon consideration of the following detailed description of the preferred embodiments exemplifying the best mode of carrying out the invention as presently perceive.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a perspective view of a granite appearing post cover placed over a typical 4″×6″ wooden post according to the present invention;

FIG. 2 is a side elevational view of the granite appearing post cover as it comes out of a mold;

FIG. 3 is a top plan view of the granite appearing post cover of FIG. 2;

FIG. 4 is a bottom plan view of the hollow granite appearing post cover of FIG. 2 after a bottom portion is cut-off;

FIG. 5 is a side elevation view of the bottom portion of the post cover of FIG. 2 after it is cut-off;

FIG. 6 is a perspective view of a granite appearing post cover according to the present invention having a circular hole in the top and bottom of the post cover for receiving and supporting a circular pole;

FIG. 7 is the bottom plan view of the granite appearing post cover of FIG. 6;

FIG. 8A and FIG. 8B together form a flow chart of a method for making the granite appearing post covers of FIG. 1 and FIG. 6.

### DESCRIPTION OF ILLUSTRATIVE EMBODIMENTS

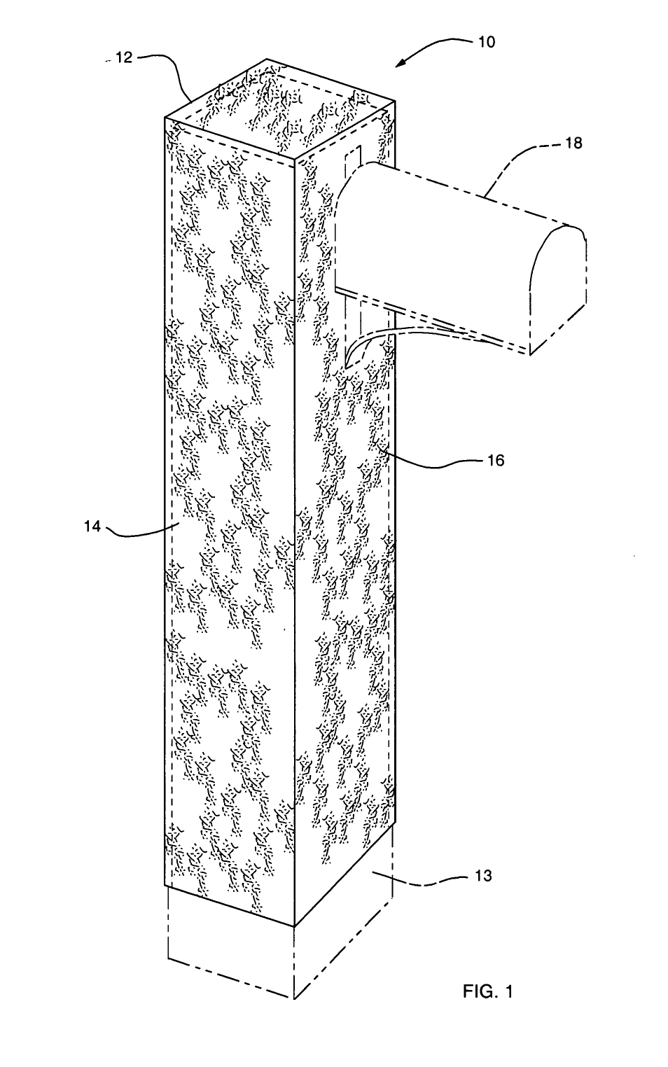

Referring to FIG. 1, a perspective view of a granite appearing post cover 10 placed over a wooden post 13 is shown according to one embodiment of the present invention. The wooden post 13 is typically approximately 4″×6″, but other size wooden posts and post covers are equally feasible and within the scope of the present invention. All outer surfaces 12, 14 & 16 of the post cover 10 comprise the look and feel of real granite, and it is made of rotationally molded polyethylene resin, a cost effective material that is almost impervious to any climate. The granite appearing post cover 10 will resist chipping, cracking or fading even in the harshest environment. The post cover 10 comprises typical dimensions for the sides of 6″×6″ and may be made of various heights depending on the applications, although many other embodiments may be implemented depending on the required dimensions. The words post and pole used herein are interchangeable and reference to one does not exclude the other.

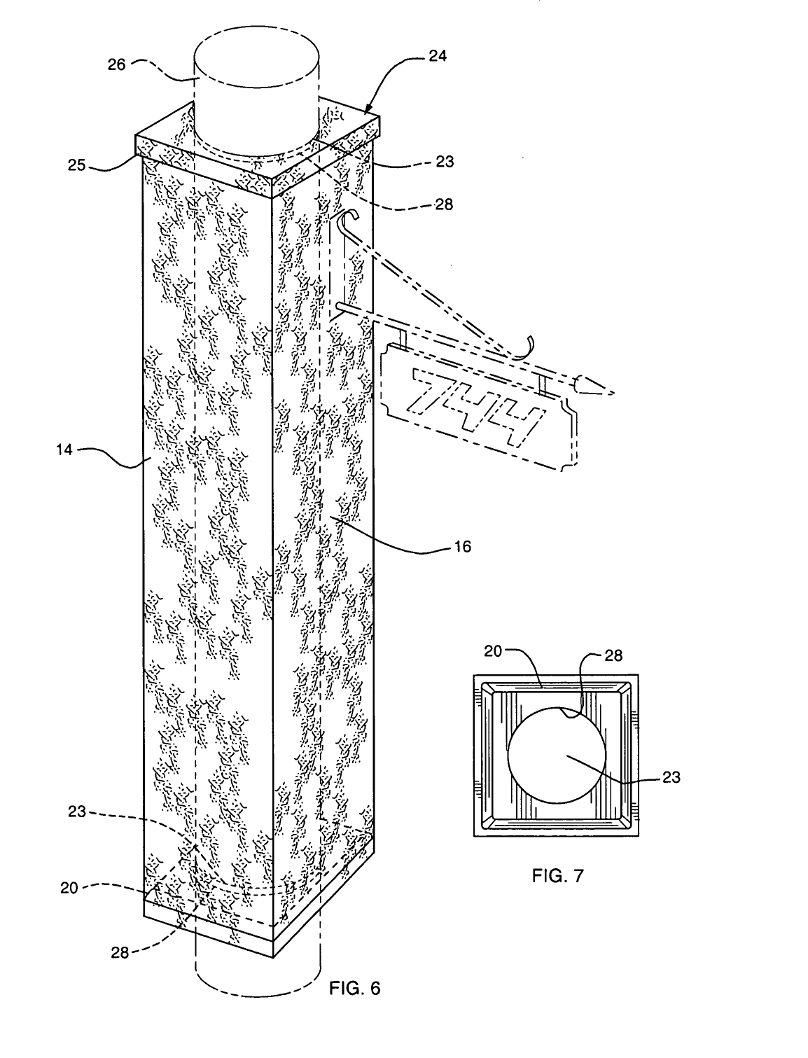

The post cover 10 is made to slip over various structures such as wooden posts, metal light poles, etc. and maybe fastened to such a structure with screws, adhesives, etc. Also, decorative or functional hardware may be fastened to the post cover 10 such as a mailbox 18 (as shown in FIG. 1), house numbers (as shown in FIG. 6), flower pot hangers, watering hose holder, lamp post head assemblies, outdoor shower assemblies, planter edging, etc.

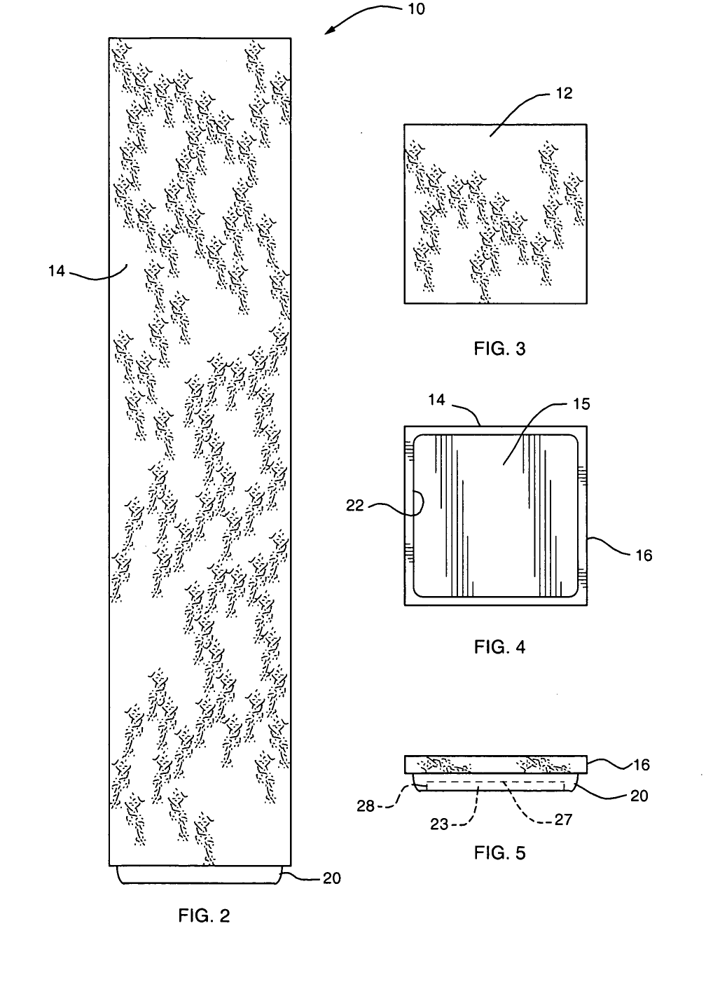

Referring to FIGS. 2, 3 and 4, FIG. 2 is a side elevational view of the granite appearing post cover of FIG. 1 as it comes out of a mold, FIG. 3 is a top plan view of the granite appearing post cover of FIG. 2, and FIG. 4 is a bottom plan view of the hollow granite appearing post cover of FIG. 2 after a bottom portion is cut-off. FIG. 4 shows the relative thickness 22 of the side walls 14, 16 and shows the inside surface 15 of top 12 of the post cover 10. The thickness of sidewalls 14, 16 is typically 0.125 inches, but this can vary depending on applications of the post cover 10.

Referring to FIG. 5, FIG. 5 is a side elevation view of the bottom portion of the post cover of FIG. 2 after the bottom portion is cut-off to customize the length of the post cover 10. A step down extension 20 is provided on the bottom of the post cover 10 when it comes out of a mold.

Referring to FIG.6, a perspective view of a granite appearing post cover 24 according to the present invention is shown having a circular hole 23 in the top and bottom of the post cover 24 for receiving and supporting a circular pole 26, so that the post cover 24 can be used in various applications, such as around a lamp post or pole 26.

Still referring to FIG. 6 and also FIG. 5, the top of the post cover 24 in FIG. 6 comprises a flange 25 which is wider than the width of the sides 14, 16 of the post cover 24. However, the flange 25 is primarily a decorative feature and the top of the post cover 24 may be the same width as the sides 14, 16 so that it is flush with the sides 14, 16 (as shown in FIG. 1). Likewise, the top of the post cover 10 in FIG. 1 may have a flange. The top and bottom sections of the mold (not shown) for making the post cover 24 may or may not have solid inwardly extending circular protrusions, and when present, such solid protrusions inwardly extend approximately 0.5 inches, and cause a thin, breakable surface 27 (see FIG. 5) of plastic resin to form on the top and bottom sections of the post cover 24 across the end of a rim 28 formed by the solid protrusions of the mold. The thin circular surface 27 of plastic resin is easily pushed through or cut out resulting in the circular hole 23 in the top and bottom of the post cover 24 for receiving the circular pole 26. For certain applications, the side mold sections may include solid protrusions for forming openings in predetermined locations on the sides 14, 16 of the post cover 24.

Referring now to FIG. 6 and FIG.7, FIG. 7 shows a bottom plan view of the post cover 24 of FIG. 6 having the circular hole 23 which is provided to accept the circular pole 26. The circular hole 23 may be left intact as shown in FIG.6, or a portion of the lower part of the post cover 24 may be cut from the post cover 24 to allow customization of the post cover length. A step down extension 20 is provided to allow the cutoff piece to be reversed and inserted back into the post cover 24 as shown in FIG. 6, thereby providing support and stability when installing over a circular pole 26.

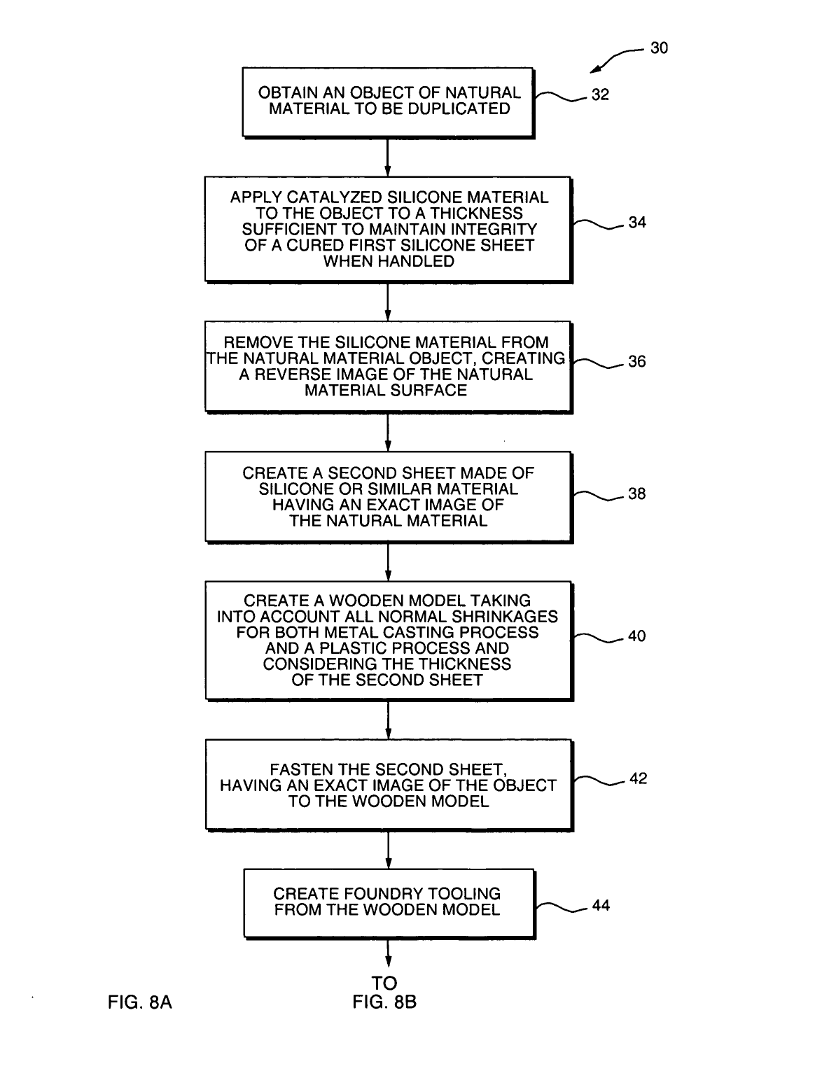

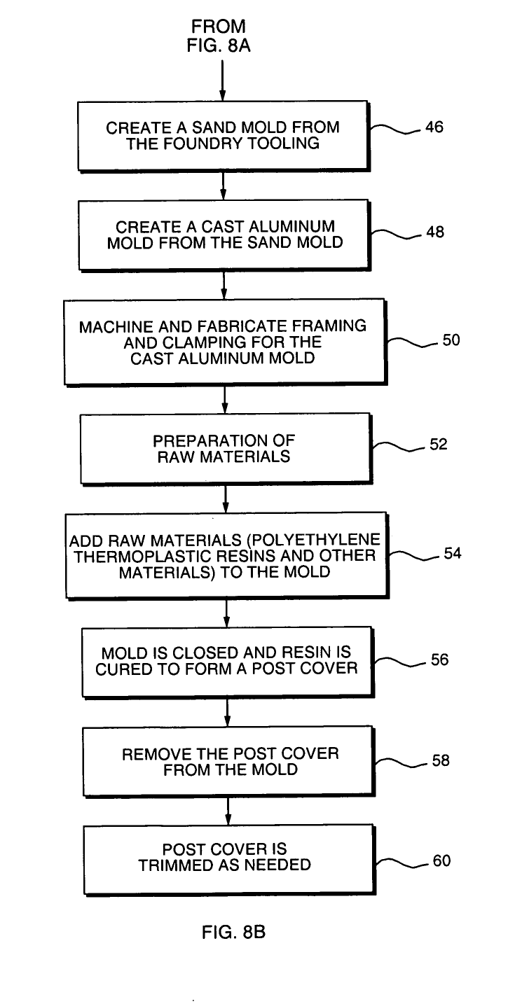

Referring now to FIG.8A and FIG. 8B, a flow chart is shown of the method 30 for manufacturing a mold that will produce the stone or granite appearing post covers of FIG. 1 and FIG. 6.

In step 32, an object of natural material such as a stone or granite post is provided. In step 34, a catalyzed, commercially available silicone material is applied to the object or natural material to a nominal thickness of approximately 0.125 inches to maintain the integrity of the first silicone sheet when cured and handled. In step 36, the first silicone sheet is removed from the object or natural material, such as stone or granite, creating a reverse image of the natural material surface. In step 38, using the first silicone sheet as a mold, a second sheet is created made of silicon or similar material known in the art having an exact image of the original natural material.

In step 40, a wooden model is created by a pattern maker, or one of ordinary skill in the art of creating wooden models, to resemble the exact shape of the post covers 10 and 24 without texturing, taking into account all normal shrinkages for both a metal casting process and a plastic process and considering the thickness of the second sheet. In step 42, the second silicone sheet is mechanically fastened to the wooden model on two sides, the second sheet having the exact image including texturing, of the original object or natural material.

In step 44, foundry tooling is created from the wooden model using methods standard to the rotational molding industry and known to one of ordinary skill in the art, such as a metal mold maker, or foundry. In step 46, foundry tooling is used to create a sand mold that is subsequently used for an industry standard cast aluminum pouring. In step 48, once the cast aluminum mold is hardened consistent with industry standards, it is extracted from the sand mold.

In step 50, the cast aluminum mold is machined and installed in metal frames equipped with fastening devices to facilitate the opening and closing of the mold for raw material filling and subsequent removal of the molded part. In step 52, raw material for the post covers 10 and 24 is prepared by the mixing of various colors of ground polyethylene resin with commercially available pigments, such as carbon black, titanium dioxide and cadmium sulfide.

In step 54, the prepared resin is added to the opened mold. In some instances, mica or other materials are first added to the mold to enhance the natural effect or appearance of the finished post covers.

In step 56, the mold is closed and passes through a normal manufacturing process on a rotational molding machine where first heat is supplied to melt the thermoplastic resin, such as polyethylene; the mold is rotated bi-axially to distribute the resin and then cooled to maintain the thermoplastic resin in the desired shape. In step 58, the mold is opened and post cover is removed.

In step 60, openings 23 are cut or trimmed in the top and bottom of the post cover 24 (see FIGS. 6 and 7) as appropriate for the intended application around a lamp pole 26.

This method produces a light, one piece post cover substantially resembling a natural material, including but not limited to, stone or granite. The post cover is unique in its ability to economically transform the appearance of an inexpensive simple wood or metal post to that of a more expensive product such as stone or granite.

This invention has been disclosed in terms of certain embodiments. It will be apparent that many modifications can be made to the disclosed apparatus without departing from the invention. Therefore, it is the intent of the appended claims to cover all such variations and modifications as come within the true spirit and scope of this invention.

What is claimed is:

1. A post cover comprising walls having a textured surface with a stone appearance, said walls being made of a molded resin.

2. The post cover as recited in claim 1, wherein said walls having a textured surface comprise a natural stone, such as, granite appearance.

3. The post cover as recited in claim 2, wherein said post cover comprises a geometric form of lightweight, rectangular sides, a closed top, and a bottom having a step-down extension.

4. The post cover as recited in claim 2, wherein said post cover comprises a geometric form of lightweight rectangular sides, a top a and bottom each having a circular opening, allowing said post cover to slip over a circular pole or post during installation.

5. The post cover as recited in claim 1, wherein said cover comprises a thermoplastic resin, including, polyethylene.

6. The post cover as recited in claim 3, wherein a lower portion of said post cover comprises said step-down extension wherein:
said lower portion is cut-off to provide a predetermined length of said post cover; and
said cut-off lower portion comprising said step-down extension, when turned around, plugs into an open end of said post cover to provide support for the open end of said post cover during storage and shipping.

7. The post cover as recited in claim 3, wherein said bottom portion of said post cover comprises said step-down extension having an opening in said bottom portion for receiving a pole.

8. The post cover as recited in claim 4, wherein said bottom of said post cover comprises a step-down extension, said bottom being cut-off to provide a predetermined length of said post cover, and said bottom, when turned around, plugs into an open end of said post cover to provide support when receiving a circular pole passing though said post cover.

9. A method for manufacturing a post cover having a textured surface with a stone appearance, such as granite, comprising the steps of:
providing an object of natural material;
applying a silicone material to said object at a predetermined thickness sufficient to maintain integrity
removing said first silicone sheet from said natural material object to create a cured first silicone sheet having a reverse image of said natural material;
creating a second silicone sheet having an exact image of said natural material, using said first silicone sheet as a mold;
making a wooden model to resemble the shape of said post cover;
fastening said second silicone sheet, having an exact image of said natural material, to said wooden model;
creating foundry tooling from said wooden model, said foundry tooling being used to create a sand mold;
pouring a melted aluminum into said sand mold to create a cast aluminum mold;
adding a resin to said cast aluminum mold;
curing said resin as said mold is rotated to form said post cover, and
removing said cured resin post cover from said mold, said cured resin post cover having said textured surface with a stone appearance of said object.

10. The method as recited in claim 9, wherein said step of adding said resin to said mold comprises the step of adding a thermoplastic resin including polyethylene.

11. The method as recited in claim 9, wherein said method comprises the step of adding mica or other additives to said mold prior to said curing step to enhance the appearance of said cured resin.

12. The method as recited in claim 9, wherein said method comprises the step of providing a step-down extension on a lower portion of said post cover.

13. The method as recited in claim 12, wherein said method comprises the steps of:
cutting-off a lower portion of said post cover having said step-down extension for providing a predetermined length of said post cover;
turning around said cut-off lower portion of said post cover; and
inserting said step-down extension of said lower portion into an open end of said post cover to provide support for said open end of said post cover.

14. The method as recited in claim 9, wherein said method comprises the step of providing a circular opening in a top end and a bottom end of said post cover for receiving a circular pole passing through said post cover.
